(19) United States
(12) Patent Application Publication
(10) Pub. No.: US 2026/0235321 A1
(43) Pub. Date: Aug. 13, 2026

(54) GAS HEATER

(71) Applicant: Tutco, LLC, Cookeville, TN (US)

(72) Inventors: Jonathan Bruce Arold, Exeter, NH (US); Ronald T. Rittenhouse, Dover, NH (US); Daniel Bourgeois, Cookeville, TN (US); Matthew Stephen Hargreaves, Kittery, ME (US)

(73) Assignee: Tutco, LLC, Cookeville, TN (US)

(21) Appl. No.: 19/151,552

(22) PCT Filed: Jan. 5, 2024
(86) PCT No.: PCT/US2024/010422

§ 371 Date: Jul. 28, 2025

Related U.S. Application Data
(60) Provisional application No. 63/484,318, filed on Feb. 10, 2023.

(30) Foreign Application Priority Data
Apr. 5, 2023 (GB) 2305089.1

(51) Int. Cl. F24H 3/04; F24H 9/1863; F24H 15/25; F24H 15/37; H05B 3/12; H05B 3/46

(52) U.S. Cl. CPC F24H 3/04; F24H 9/1863; F24H 15/25; F24H 15/37; H05B 3/12; H05B 3/46

(57) ABSTRACT

One aspect of the invention provides a gas heater including: a structure that defines a gas flow path having an upstream end and a downstream end; a first heating element positioned in the upstream end of the flow path; a second heating element positioned downstream of the first heating element in the flow path; and a third heating element positioned downstream of the second heating element in the flow path. The second heating element has a larger cross-sectional dimension than the first heating element. The third heating element has an equal or larger cross-sectional dimension than the second heating element. The first heating element, the second heating element, and the third heating element are an identical material.

### CROSS-REFERENCE TO RELATED APPLICATIONS 2305089.1

This application claims the benefit of priority to U.K. Patent Application No. 2305089.1 filed Apr. 5, 2023 and U.S. patent application Ser. No. 63/484,318, filed Feb. 10, 2023. The entire contents of each application is hereby incorporated by reference herein.

### TECHNICAL FIELD

The field relates to heaters and particularly to gas heaters having a resistive element powered by an electric current.

### BACKGROUND

Conventional gas heaters include an enclosure that houses a heating element and that defines a flow path. Electric current passes through the resistive element to cause warming of the resistive element as well as air passing along the flow path. The amount of heat generated by the resistive elements depends, among other things, on the resistance value of the resistive element.

### SUMMARY OF THE INVENTION

One aspect of the invention provides a gas heater including: a structure that defines a gas flow path having an upstream end and a downstream end; a first heating element positioned in the upstream end of the flow path; a second heating element positioned downstream of the first heating element in the flow path; and a third heating element positioned downstream of the second heating element in the flow path. The second heating element has a larger cross-sectional dimension than the first heating element. The third heating element has an equal or larger cross-sectional dimension than the second heating element. The first heating element, the second heating element, and the third heating element are an identical material.

This aspect of the invention can have a variety of embodiments. The first heating element, the second heating element, and the third heating element can each have a substantially constant resistance relative to temperature. The first heating element, the second heating element, and the third heating element can be ferritic iron-chromium-aluminum (FeCrAl) alloy. The FeCrAl alloy can include chromium in the range of 20-30% by weight and aluminum in the range of 4-7.5% by weight.

The first heating element, the second heating element, and the third heating element can be wired in series.

The first heating element, the second heating element, and the third heating element can have a substantially uniform mass per unit of volume.

The first heating element, the second heating element, and the third heating element can each include a material configured to withstand high temperatures up to 1,500° C.

The gas heater can further include a temperature monitoring system including: a plurality of infrared temperature sensors; and at least one thermocouple disposed on one end of the first heating element or the third heating element. The temperature monitoring system can be configured and adapted to: measure a temperature of a portion of the first heating element, the second heating element, and the third heating element; or measure a temperature of a gas provided through the gas flow path.

The gas heater can further include a system for providing gas through the gas flow path, the system being fluidically connected to the gas flow path of the structure. The system for providing gas can be adapted and configured to provide a hydrogen gas.

The gas heater can further include a system adapted and configured to: provide electric energy to the first heating element, the second heating element, or the third heating element to heat gas on the gas flow path in the upstream portion; heat the second heating element to increase the resistivity of the second heating element; and provide electric energy to the second heating element to heat gas on the flow path in excess of the first heating element temperature limit.

In one embodiment: the first heating element includes a first heating coil, the first heating coil being a 15-gauge wire (~1.450-mm diameter); the second heating element includes a second heating coil, the second heating coil being a 14-gauge wire (~1.628-mm diameter); and the third heating element includes a third heating coil, the third heating coil being a 14-gauge wire (~1.628-mm diameter).

Another aspect of the invention provides a device including: a first mandrel configured and adapted to support a first heating element, the first mandrel including a distal end and a proximal end; a second mandrel configured and adapted to support a second heating element, the second mandrel including a distal end and a proximal end, the distal end of the second mandrel being positioned adjacent to the proximal end of the first mandrel, the second mandrel being axially aligned with the first mandrel; and a union coil disposed between the first mandrel and the second mandrel, the union coil being configured to rigidly couple the first and the second mandrel.

This aspect of the invention can have a variety of embodiments. The device can further include: a third mandrel configured and adapted to support a third heating element, the third mandrel including a distal end and a proximal end, the distal end of the third mandrel being positioned adjacent to the proximal end of the second mandrel, the third mandrel being axially aligned with the first and second mandrel; and another union coil disposed between the second mandrel and the third mandrel, the another union coil being configured to rigidly couple the second and the third mandrel.

Each of the mandrels can be made from a ceramic material. Each of the union coils can be made from a metallic material.

The first mandrel and the second mandrel can have an axial bore. In one embodiment, the device does not include an electrically conductive element within the axial bore.

The device can include a pin within the axial bore. The pin can span between the first mandrel and the second mandrel, but not extend more than one half or one quarter of a length of either of the first mandrel and the second mandrel.

The first mandrel and the second mandrel can each have complementary helical grooves adapted and configured to receive the union coil. The first mandrel and the second mandrel can be dielectric mandrels. The first mandrel and the second mandrel can be ceramic.

### BRIEF DESCRIPTION OF THE FIGURES

FIG. 1 is an isometric cross-sectional view of a dual-stage gas heater according to one illustrative embodiment.

FIG. 2 is a side view of dual-stage heater of the embodiment shown in FIG. 1.

FIG. 3 is a cross-sectional side view of a multi-stage heater having stages 306a-306c of increasing heating-element-wire thickness in a downstream direction (left to right) according to another illustrative embodiment.

FIG. 4 is a cross-sectional side view of a portion of a multi-stage heater including an interface between adjacent stages of a heater showing adjacent mandrel sections coupled together by a helical union coil threaded over ends of each of the mandrel sections according to another illustrative embodiment.

FIG. 5 is a cross-sectional side view of a portion of a multi-stage heater including an interface between adjacent stages of a heater showing adjacent mandrel sections coupled together by pin according to another illustrative embodiment.

### DETAILED DESCRIPTION

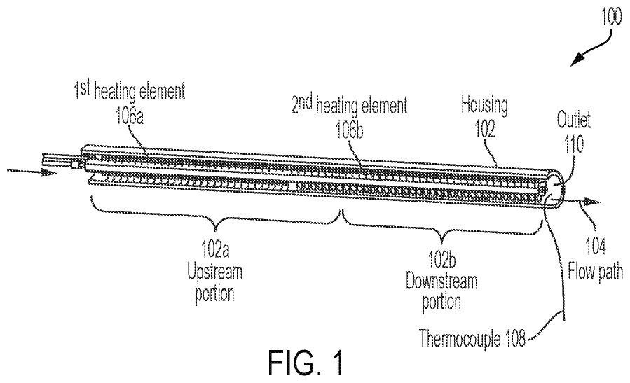

Turn now to FIG. 1 that shows a cross-sectional view of a gas heater 100 according to one illustrative embodiment. The heater 100 can include a cylindrical, insulative housing 102 that defines a flow path 104 for gas to be heated. Two or more resistive heating elements 106a, 106b can be positioned in upstream and downstream portions of the housing 102a, 102b, respectively. A first thermocouple (not depicted) can be positioned between the first and second heating elements 106a, 106b and a second thermocouple 108 can be positioned downstream of the second heating element 106b near an outlet 110 of the housing 102. A controller (not shown) can be programmed to control the flow of current to the first and second heating elements 106a, 106b based on a desired temperature set point and temperature readings that are taken at one or both of the thermocouples. Suitable thermocouples (e.g., Type K or Type S, platinum, tungsten, radium) can be selected based on the anticipated temperatures.

The housing 102 can define a flow path 104 for gas to be heated and at least partially encloses the heating elements 106a, 106b to help direct heat to the gas. In the illustrative embodiment of FIG. 1, the housing 102 has a cylindrical shape and is constructed of a ceramic material. It is to be appreciated that other geometries and materials are also possible. According to some alternate embodiments, the housing 102 includes a reflective (e.g., thermal-reflective, infrared-reflective, and the like) interior surface to help direct heat onto gas flowing along the flow path 104.

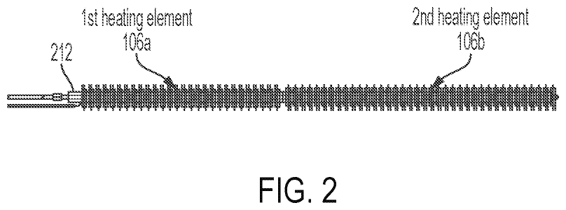

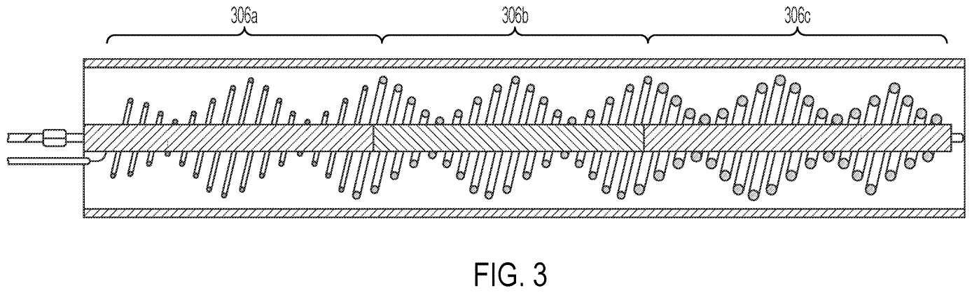

The heater 100 shown in FIGS. 1 and 2 includes a central mandrel 212 that provides a supportive structure for resistive wire of the heating elements 106a, 106b and that is shaped and sized to fit internally to the housing 102. The central mandrel 212 can be formed from a high-temperature dielectric such as a ceramic. The resistive wires, as shown, are wound about the mandrel 212 in a manner that positions the wire within the flow path 104 of gas to optimize heat transfer. The mandrel 212 can include a hollow core to receive lead wires of the heating elements and/or the thermocouples. The central mandrel 212 advantageously provides mechanical support to the resistive wire of the heating elements 106a, 106b, which may expand and/or relax when heated and cause a short circuit if thermally deformed adjacent winds contact each other. In some embodiments, the mandrel 212 includes helical flutes or threads 514 to receive the wires 516 of the heating elements 106a, 106b such as depicted in FIG. 5.

The heating elements 106a, 106b can be arranged serially in an electrical circuit along with a controller and a lead that passes through an interior of the mandrel. The heating elements 106a, 106b can be constructed of a resistive wire that has a substantially constant resistivity with respect to temperature. According to some embodiments, the resistive wire of the heating elements 106a, 106b are made of a ferritic iron-chromium-aluminum (FeCrAl) alloy, such as KANTHAL® that may be sourced from Kanthal Heating Technology of Amherst, New York. In one embodiment, the FeCrAl includes chromium in the range of 20-30% by weight and aluminum in the range of 4-7.5% by weight. In another embodiment, the resistive wire can be nickel-chromium.

In one embodiment, a wire can be considered to have substantially constant resistivity with respect to temperature if the resistance varies less than 5% (e.g., about 4% or about 3%) between room temperature and the operating temperature of the first heating element.

In some embodiments, one or more of the heating elements 106a, 106b includes two sub-stages of the same material, but having two different gauges. For example, the first sub-stage can have a finer gauge that has a higher resistance than a downstream sub-stage having a coarser gauge.

In one embodiment, a first heating element includes a first heating coil, a second heating element includes a second heating coil, and a third heating element includes a third heating coil. The heating coils can be formed from wire having gauges of 15 (~1.450-mm diameter), 14 (~1.628-mm diameter), and 14 (~1.628-mm diameter), respectively.

The heating elements 106a, 106b can be constructed of a refractory resistive wire having a resistivity that increases with temperature, such as tungsten, molybdenum, tantalum, and the like. In some embodiments, the second heating element is formed from a ceramic-like wire alternative such as molybdenum disilicide and the like.

The material of the heating elements 106a, 106b can be capable of operating at high temperatures, including temperatures up to and exceeding 1500 C.

The gauges of both the first and the second heating element 106a, 106b can be optimized to accommodate various electrical voltages. Further, the heating elements can be solid or stranded.

The heating elements 106a, 106b can be wound about the central mandrel in a manner calculated to increase or maximize thermal density, mass, and/or surface area of the heating elements exposed to the gas contained in the housing. For example, the wire of the heating elements 106a, 106b can be wound substantially helically with respective to the central mandrel. The heating elements 106a, 106b can also have serpentine loops along the helical path that radiate inward and outward with respect to a central axis. One exemplary winding pattern is described and depicted in U.S. Pat. No. 3,551,643.

In some embodiments, an axial gap is formed between the resistive heating elements, which can prevent or limit upstream migration of heat from the second heating element 106a, 106b that could damage the first heating element. In some cases, the gas flow may also limit upstream migration of thermal dispersion to the first heating element 106a.

Adjacent heating elements (e.g., first and second elements 106a, 106b) can be joined by welding.

Multiple heaters (e.g., 16) can be used in parallel to heat a desired volume of gas.

### Control

Temperature measurement sensors may be positioned at various points of the gas heater 100 to measure operating temperatures. Measured temperatures may be used by the controller or merely for reference. Infrared sensors may also be used, particularly for temperatures that exceed 1200 C, such as wire temperatures of the heating elements or the gas at the outlet of the heater.

The principles of how to use feedback (e.g., from a temperature sensor such as thermocouple, a thermistor, infrared and the like) in order to modulate operation of a component are described, for example, in Karl Johan Astrom & Richard M. Murray, Feedback Systems: An Introduction for Scientists & Engineers (2008) and can be implemented using a Proportional-Integral-Derivative (PID) controller and the like.

In some embodiments, a temperature sensor such as an infrared imaging device can be utilized to protect the heater against operation at temperatures over specification that may damage the heater (e.g., the first resistive heater(s)). Such a condition may be caused by an interruption of flow of the gas to be heated, which acts as a heat sink relative to the resistive heating elements. Such an over-heat-prevention system is described in U.S. Pat. No. 10,736,180.

In some embodiments, a current detector can be coupled to a portion of the second heating element. The current detector can identify the amount of current reaching that particular coupling point to the second heating element. Based on the dimensions (length, volume, and the like) of the second heating element and the detected current (and the current inputted into the system), the current detector can determine the resistivity of the second heating element at a given time. This may be advantageous, particularly as an indirect measurement of temperature of the system, and/or for detecting operating errors of the system.

The control system can be a computing device such as a microcontroller (e.g., available under the ARDUINO® OR IOIO™ trademarks), general purpose computer (e.g., a personal computer or PC), workstation, mainframe computer system, and so forth. The control system (“control unit”) can include a processor device (e.g., a central processing unit or “CPU”), a memory device, a storage device, a user interface, a system bus, and a communication interface.

### Optional Independent Control of Heating Elements

Although embodiments of the invention depict heating elements wired in series, embodiments of the invention could wire the different types of resistive heating elements on separate circuits.

### Coupling of Adjacent Mandrel Portions

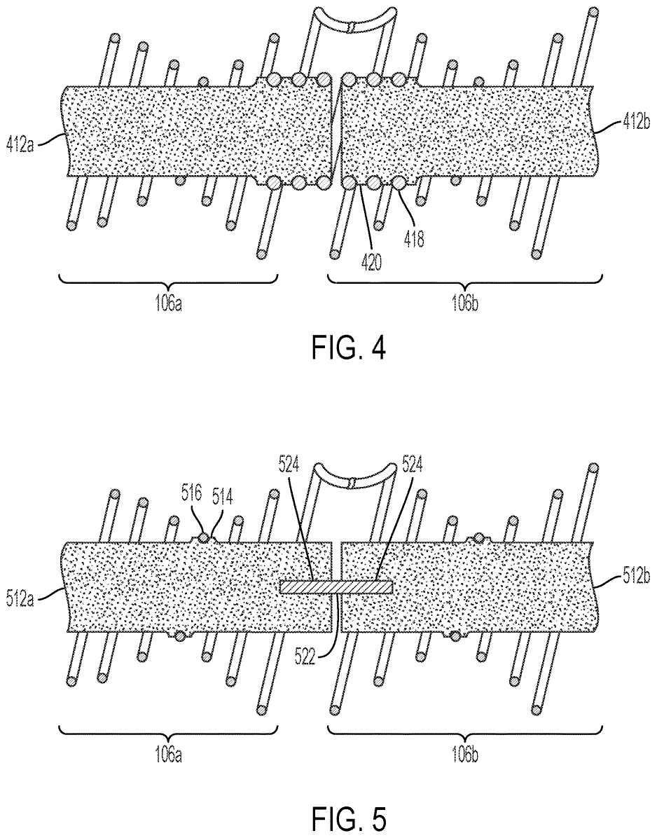

Referring now to FIGS. 4 and 5, it is not practical to manufacture ceramic mandrel members 212 longer than about 1′ (~0.3 m). Multiple mandrel members 212 could be placed over a supporting rod, but a metal rod would serve as a grounding path that can induce short circuiting. Embodiments of the invention provide improved methods for coupling multiple mandrel members in order to achieve desired lengths for heaters.

Referring to FIG. 4, one embodiment of the invention utilizes a helical union coil 418. The helical union coil 418 can be mate with adjacent mandrel members 412a, 412b by threading over complementary helical grooves 420 on the outside of the mandrel members 412a, 412b.

Referring to FIG. 5, another embodiment of the invention utilizes a relatively short pin 522 that is received in corresponding bores 524 of adjacent mandrel members 512a, 512b. The bores 524 can be relatively shallow or can extend along the entire length of the mandrel member 512a, 512b.

The short length of the pin 522 and the helical union coil 418 prevents either from serving as a short-inducing path to ground, e.g., even though helical union coil 418 may be metallic.

The heating elements 106a, 106b can be formed over the mandrel members 412a, 412b, 512a, 512b before or after coupling of the mandrel members 412a, 412b, 512a, 512b. Adjacent heating elements 106a, 106b can be coupled via welding (e.g., TIG welding) as depicted.

1. A gas heater, comprising:
a structure that defines a gas flow path having an upstream end and a downstream end;
a first heating element positioned in the upstream end of the flow path;
a second heating element positioned downstream of the first heating element in the flow path, the second heating element having a larger cross-sectional dimension than the first heating element; and
a third heating element positioned downstream of the second heating element in the flow path, the third heating element having an equal or larger cross-sectional dimension than the second heating element;
wherein:
the first heating element, the second heating element, and the third heating element consist of an identical material;
the first heating element, the second heating element, and the third heating element are wound about a dielectric mandrel that positions the first heating element, the second heating element, and the third heating element within the gas flow path; and
the mandrel comprises at least two mandrel members coupled to each other by one or more of:
a helical union coil threaded over complementary helical grooves on the at least two mandrel members; or
a pin received within bores within the at least two mandrel members.

2. A gas heater of claim 1, wherein the first heating element, the second heating element, and the third heating element each have a substantially constant resistance relative to temperature.

3. A gas heater of claim 1, wherein the first heating element, the second heating element, and the third heating element consists of ferritic iron-chromium-aluminum (FeCrAl) alloy.

4. The gas heater of claim 3, wherein the FeCrAl alloy comprises chromium in the range of 20-30% by weight and aluminum in the range of 4-7.5% by weight.

5. A gas heater of claim 1, wherein the first heating element, the second heating element, and the third heating element are wired in series.

6. A gas heater of claim 1, wherein the first heating element, the second heating element, and the third heating element have a substantially uniform mass per unit of volume.

7. The gas heater of claim 1, wherein the first heating element, the second heating element, and the third heating element each comprise a material configured to withstand high temperatures up to 1,500° C.

8. The gas heater of claim 1 further comprising:
a temperature monitoring system including:
a plurality of infrared temperature sensors; and
at least one thermocouple disposed on one end of the first heating element or the third heating element,
wherein the temperature monitoring system is configured and adapted to:
measure a temperature of a portion of the first heating element, the second heating element, and the third heating element; or
measure a temperature of a gas provided through the gas flow path.

9. The gas heater of claim 1 further comprising:
a system for providing gas through the gas flow path, the system being fluidically connected to the gas flow path of the structure.

10. The gas heater of claim 9, wherein the system for providing gas is adapted and configured to provide a hydrogen gas.

11. The gas heater of claim 1 further comprising:
a system adapted and configured to:
provide electric energy to the first heating element, the second heating element, or the third heating element to heat gas on the gas flow path in the upstream portion;
heat the second heating element to increase the resistivity of the second heating element; and
provide electric energy to the second heating element to heat gas on the flow path in excess of the first heating element temperature limit.

12. The gas heater of claim 1, wherein:
the first heating element includes a first heating coil, the first heating coil being a 15-gauge wire;
the second heating element includes a second heating coil, the second heating coil being a 14-gauge wire; and
the third heating element includes a third heating coil, the third heating coil being a 14-gauge wire.

13. A device comprising:
a first mandrel configured and adapted to support a first heating element, the first mandrel including a distal end and a proximal end;
a second mandrel configured and adapted to support a second heating element, the second mandrel including a distal end and a proximal end, the distal end of the second mandrel being positioned adjacent to the proximal end of the first mandrel, the second mandrel being axially aligned with the first mandrel; and
a union coil disposed between the first mandrel and the second mandrel, the union coil being configured to rigidly couple the first and the second mandrel.

14. The device of claim 13 further comprising:
a third mandrel configured and adapted to support a third heating element, the third mandrel including a distal end and a proximal end, the distal end of the third mandrel being positioned adjacent to the proximal end of the second mandrel, the third mandrel being axially aligned with the first and second mandrel; and
another union coil disposed between the second mandrel and the third mandrel, the another union coil being configured to rigidly couple the second and the third mandrel.

15. The device of claim 14, wherein each of the mandrels are made from a ceramic material.

16. The device of claim 14, wherein each of the union coils are made from a metallic material.

17. The device of claim 14, wherein:
the first mandrel and the second mandrel have an axial bore.

18. The device of claim 17, wherein the device does not include an electrically conductive element within the axial bore.

19. The device of claim 17, wherein the device includes a pin within the axial bore, the pin spanning between the first mandrel and the second mandrel, but not extending more than one half or one quarter of a length of either of the first mandrel and the second mandrel.

20. The device of claim 13, wherein the first mandrel and the second mandrel each have complementary helical grooves adapted and configured to receive the union coil.

21. (canceled)

22. (canceled)
